(19) United States
(12) Patent Application Publication
(10) Pub. No.: US 2009/0234717 A1
(43) Pub. Date: Sep. 17, 2009

(54) TARGETED INFORMATION CONTENT DELIVERY USING A COMBINATION OF ENVIRONMENTAL AND DEMOGRAPHIC INFORMATION

(76) Inventors: Randall T. Wiggins, Madison, WI (US); Christopher W. Kelly, Madison, WI (US); Terence F. Kelly, Madison, WI (US); Irene S. Cash, McFarland, WI (US); Sara J. Ifert, Verona, WI (US)

Correspondence Address: BOYLE FREDRICKSON S.C., 840 North Plankinton Avenue, MILWAUKEE, WI, 53203, US

(21) Appl. No.: 12/425,991

(22) Filed: Apr. 17, 2009

Related U.S. Application Data
(63) Continuation-in-part of application No. 10/270,847, filed on Oct. 15, 2002.

(51) Int. Cl. G06Q 30/00; G06N 5/02; G06Q 50/00; G06F 17/30

(52) U.S. Cl. 705/10; 705/14; 706/52; 707/3; 706/47; 707/E17.014; 707/E17.018

(57) ABSTRACT

A system for targeting electronic advertising using weather related parameters simplifies the complexity of such a targeting system by using predefined templates that reduce multiple weather data into a quantitative metric that may be used in real time for automatic selection among a variety of different competing advertisements. The templates may conflate not only weather related data but also information about the consumer and may direct that the weather related data be from dates before or after the date of the delivery of the advertisement. Method of refining the templates and automatically assigning them are also disclosed.

### CROSS-REFERENCE TO RELATED APPLICATIONS

This application is a continuation in part of U.S. application Ser. No. 10/270,847 filed Oct. 15, 2002.

### STATEMENT REGARDING FEDERALLY SPONSORED RESEARCH OR DEVELOPMENT

--

### FIELD OF THE INVENTION

This invention pertains generally to systems and methods for targeting and delivering information content, such as marketing information or advertisements, over a content distribution system, such as the Internet, to those who are most likely to be interested in receiving such content, and, more particularly, to a system and method for targeting such content delivery based upon a combination of demographic and other information.

### BACKGROUND OF THE INVENTION

Businesses have a need to market their products and services to potential customers. Valuable marketing resources can be wasted by delivering advertisements to those who are unlikely to be interested in the businesses' products or services. Marketing and advertising campaigns can be much more effective and efficient when advertisements are targeted to those potential customers who are most likely to desire the products and services offered for sale by the business. Targeted marketing has been, and can be, applied in various ways, and with various degrees of accuracy and effectiveness, to almost any method for delivering advertising materials to potential customers. For example, a neighborhood restaurant may mail out menus to residents in the neighborhoods around the restaurant, as these are the most likely patrons of the restaurant. The neighborhood restaurant would not waste its marketing resources on sending menus to those living in towns many miles away from the restaurant. In a broad sense, this is a type of targeted marketing, based on geographic location. Television advertisers may place their advertisements to appear during television shows that are related to the products or services being offered. For example, a garden center may advertise during a television show related to gardening, and not advertise during a broadcast of other shows or events, such as a television show on auto repair. This is targeted marketing based on potential customer interest factors. The advertiser may believe, quite reasonably, that those who watch a show on gardening are more likely to be interested in purchasing gardening supplies than those who are watching a show on auto repair.

New information delivery media, such as the Internet, have expanded the opportunities for targeting advertising more directly to those specific individuals who are most likely to respond to the advertisement by purchasing a product or service. The interactive nature of the Internet, as well as the ability to gather and store vast amounts of demographic information via the Internet, makes more highly specified targeted marketing possible. The interactive nature of the Internet allows an advertiser to determine directly what types of products or services an individual is likely to be interested in, and thus what types of advertisements to deliver to the individual. For example, a web site which sells books may monitor a customer's purchases, or even product descriptions which the customer has merely looked at, and generate and direct advertisements to the customer, e.g., via email messages sent to the customer's email address or via advertisements placed on the web page viewed by the customer the next time the customer views the web site, based on the customer's past purchases at the web site. For example, a customer who has, in the past, ordered or looked at descriptive material for gardening books may be presented with advertisements, in an e-mail message or on the book seller's web site, for the latest gardening book releases and/or other gardening related products or services.

The Internet can also provide a tool for gathering and filtering demographic information, to identify potential recipients of targeted marketing materials, in many other ways. Such demographic information may be entered by individuals into one or more web sites on the Internet voluntarily, in exchange for goods or services provided by web site publishers. For example, in exchange for information available at a web site, a user may voluntarily enter demographic information such as the user's address, sex, age, income level, activities of interest, etc. This demographic information can be gathered and used to direct targeted advertising materials to those Internet users who are most likely to be interested in the products or services being offered. User demographic data may also be mined from the Internet without the user's directly entering such information. For example, an Internet service provider may record which Internet sites are visited by which of the provider's customers. (The customers preferably are notified in advance that such information gathering will take place.) This information may be used by the Internet service provider, or sold to others, to direct targeted advertising to individuals based on their interests as determined from the sites that they visit.

The opportunities for directing targeted advertising to Internet users has resulted in the development of automated software based systems for designing advertising campaigns and for determining automatically which advertisements should be delivered to which Internet users to optimize the effectiveness of such advertisements. For example, such a system may allow an operator thereof to select desired attributes for a viewer of an advertisement campaign from a set of categories and possible values that have been established in the system. These attribute sets can be combined to specify which campaigns a specific viewer is eligible to receive. Any given viewer may be eligible to receive many different advertisements at a particular viewing. The automated system may be called upon to find the most valuable advertisement to deliver based on a variety of dynamic criteria. The system may automatically balance competing requirements, such as delivery of a certain advertisement a certain number of times in a month, avoiding repeated delivery of the same advertisement to a specific viewer, etc., to determine which advertisements should be directed to which viewers at which times. An example of such an automated advertising management system is the AdManager, offered for sale by Engage, Inc. of Andover, Mass. Such an automated advertising management system may provide other features, such as the ability to direct individual advertisements from a series of advertisements to an Internet viewer in a sequence based on which advertisements have previously been shown to the viewer (session advertising), the ability to track whether a viewer takes action after viewing an advertisement (such as by clicking on the advertisement to obtain further information or to purchase a product or service), and the ability to provide reporting of such viewer response data to a system operator in a user friendly format.

The Internet also provides a medium for delivering personalized user specific information content other than marketing or advertisement content to Internet users. An example of such other information content is personalized weather information. For example, the Internet may be used as a medium for requesting, delivering, and receiving personalized weather reports of current and future weather conditions by individual or business users for particular locations of interest defined by the individual or business user. A provider of personalized weather reports may provide to a user over the Internet a graphical user interface which allows the user to establish an individualized user profile in which the user may define a particular location of interest (e.g., home, place of business, etc.). The provider may then generate personalized weather reports of current and forecast weather conditions (e.g., using high geographic and temporal resolution weather forecast model data) for the user specified location of interest, and deliver such personalized weather reports to the user at a user contact address. The user contact address may be, e.g., a personalized Internet web page established by the provider, an email address, a pager, cell phone, PDA, etc, or any combination of the above. An example of such a system and method for providing personalized weather reports is described in U.S. patent application Ser. No. 09/547,195, filed Apr. 12, 2000, and in U.S. patent application Ser. No. 09/686,029, filed Oct. 11, 2000. Such a system or method may also allow a user to identify activities in which the user is interested in participating at a user specified location, and preferred weather conditions for those activities, and may provide to the user an indication of whether or not the preferred weather conditions are likely to be satisfied at the specified location at any time in the future, e.g., based on high resolution weather forecast model data.

What is desired is an improved system and method for targeting the delivery of information content, e.g., targeted advertisements, to individuals or businesses, e.g., Internet users, based on a combination of information including demographic information related to the individual or business user, as well as environmental information, related to environmental conditions experienced by or predicted to be experienced by the individual or business. Content delivery based on a combination of environmental and demographic information will allow certain types of information content to be delivered more accurately to those who are most likely to be interested in such information, while minimizing the generation and delivery of such information content to those who are unlikely to be interested. In particular, what is desired is a system and method for targeting the delivery of information content, such as advertising campaigns, to individuals or businesses based on a combination of demographic information related to those individuals or businesses, e.g., a location of interest defined by an individual or business user, and current or forecast weather conditions for the user specified location of interest.

### SUMMARY OF THE INVENTION

The present invention provides a system and method for targeting the delivery of information content to individual and/or business content recipients based on a combination of environmental and demographic information factors. For example, in accordance with the present invention, an advertising campaign may be targeted at those potential individual or business content recipients who are most likely to be interested in the products or services offered for sale based upon demographic information relating to those individuals and businesses, e.g., a location of interest specified by the individual or business, and environmental conditions, e.g., weather conditions affecting or likely to affect the location of interest of those individual or business content recipients. The present invention may be implemented in software in a computer system which includes a user profile database which includes location of interest information and other demographic information (including lifestyle information) for a plurality of potential individual or business content recipients. Environmental information, e.g., weather forecast data, is generated or obtained by the system for the locations of interest of the various potential content recipients. Based on a combination of the environmental conditions for the potential recipient's location of interest, and other potential recipient demographic/lifestyle information, a determination is made whether or not particular information content, e.g., an advertisement, is delivered to the potential content recipient. The targeted content may be delivered to the content recipient via the Internet, e.g., to a web page generated for the content recipient or via an email message, or via other means for delivering the information content to the recipient. Targeted information content delivered to a recipient based on a combination of environmental and demographic information in accordance with the present invention is most likely to be of value to, and responded to by, the information content recipient.

An exemplary system for targeting information content delivery using a combination of environmental and demographic information in accordance with the present invention may be implemented in software in a conventional computer system. The computer system in which the invention is implemented preferably may be in communication with various potential content recipient's (e.g., individual and businesses) computer systems, e.g., via the Internet, or other potential content recipients' communication devices (e.g., pagers, digital cell phones, personal digital assistants (PDAs)) by which targeted information content may be delivered to, and demographic and other information received from, the potential content recipients.

A system for targeting information content delivery in accordance with the present invention includes access to a user profile database. The user profile database includes information related to a plurality of potential content recipients (e.g., individuals and/or businesses). Such information includes at least locations of interest of the potential content recipients, and preferably may also include other demographic information (e.g., potential recipient name, sex, income level, etc.) and lifestyle information (e.g., activities in which the potential recipient is interested in participating).

The system also has access to, or the ability to generate, environmental information related to potential content recipients' locations of interest. For example, such environmental information may include weather data for the potential recipients' locations of interest. Such weather data may include past, current, and/or forecast weather conditions for the locations of interest. Forecast weather conditions for the locations of interest preferably may be generated or derived from high geographic and temporal resolution weather forecast model data for the locations of interest. Other environmental data relevant to locations of interest to the potential content recipients, e.g., pollen count, earthquakes, smog, etc. may also be provided to or accessible by a system for targeting information content delivery in accordance with the present invention.

A content delivery decision module combines the environmental data, e.g., high resolution weather forecast data, with demographic information, e.g., location of interest and other information provided in the user profile database, to determine which information content (if any) should be delivered to which potential content recipient based on the combined environmental and demographic data. The content delivery decision uses the combined environmental and potential content recipient demographic data to determine which information content is likely to be most valuable to a potential content recipient given environmental conditions and the potential recipient's location of interest/demographic/lifestyle profile. For example, the information content to be delivered to the content recipient may include an advertising campaign. In this case, the content delivery decision module may base the determination of which advertisements will be delivered to which potential recipients at what times based on a combination of content recipient demographic/lifestyle data (e.g., recipient location of interest) and, e.g., forecast weather conditions for the recipient's locations of interest, such that the advertisement campaign is delivered to selected potential content recipients who are most likely to respond to the advertisements.

Having determined which information content will be delivered to which content recipients, and when, based on a combination of environmental and content recipient demographic data, a personalized content delivery module may deliver the selected information content to the targeted content recipients. The selected information content may be delivered to a content recipient's computer system via an e-mail message, or, for example, to a personalized web page generated by a system in accordance with the present invention and accessible at a web page address provided to the content recipient. Information content may be delivered to the content recipient's computer and/or to another recipient communication device, e.g., a digital pager, digital cellular phone, personal digital assistant (PDA), portable navigation device etc. The information content may be delivered to the targeted recipient either by itself, or in combination with other information that may be of value to the user. For example, a personalized targeted advertisement based on a combination of user profile location of interest/demographic/lifestyle data and forecast weather conditions for the location of interest may be included as part of a personalized weather report provided to the content recipient, e.g., at a recipient accessible personalized weather report web page.

Further objects, features, and advantages of the invention will be apparent from the following detailed description taken in conjunction with the accompanying drawings.

### BRIEF DESCRIPTION OF THE DRAWINGS

In the drawings:

FIG. 1 is a schematic block diagram of an exemplary system for targeting and delivering targeted information content using a combination of environmental and other information in accordance with the present invention.

FIG. 2 is an exemplary user profile set-up menu user interface for use in obtaining user profile information, including location of interest and other demographic and lifestyle information, for use in a system and method for targeting information content delivery to selected content recipients using a combination of environmental and location of interest and other demographic/lifestyle information in accordance with the present invention.

FIGS. 3 and 4 illustrate in overview an exemplary method for delivering different targeted advertising information to different potential information content recipients based on a combination of recipient demographic information and weather forecast data in accordance with the present invention;

FIG. 5 is a schematic flow chart diagram of an exemplary method for delivering targeted information content (advertisements) to selected information content recipients using a combination of recipient demographic information and weather forecast data in accordance with the present invention;

FIG. 6 is a data flow diagram showing use of templates to manage complex weather data by mathematically reducing multiple weather parameters to simple numeric index values;

FIG. 7 is a block diagram showing the use of service rules to rank multiple advertisements for serving based on the index values;

FIG. 8 is a simplified flowchart showing the steps of selecting an advertisement for serving among competing advertisements in real-time using predictive inventory;

FIG. 9 is a flow diagram showing a system for developing a market in weather-targeted advertising by application of templates against predicted weather parameters;

FIG. 10a and FIG. 10b are graphs respectively of service times of an advertisement both under conditions that meet the advertisement's service rules and conditions that do not, and a bar chart showing the relative success of the advertisements based on their service times with respect to the templates and service rules; and

FIG. 11 is a flow diagram showing automatic templates identification using key words associated with the templates and applied to text of the advertisement.

### DETAILED DESCRIPTION OF THE INVENTION

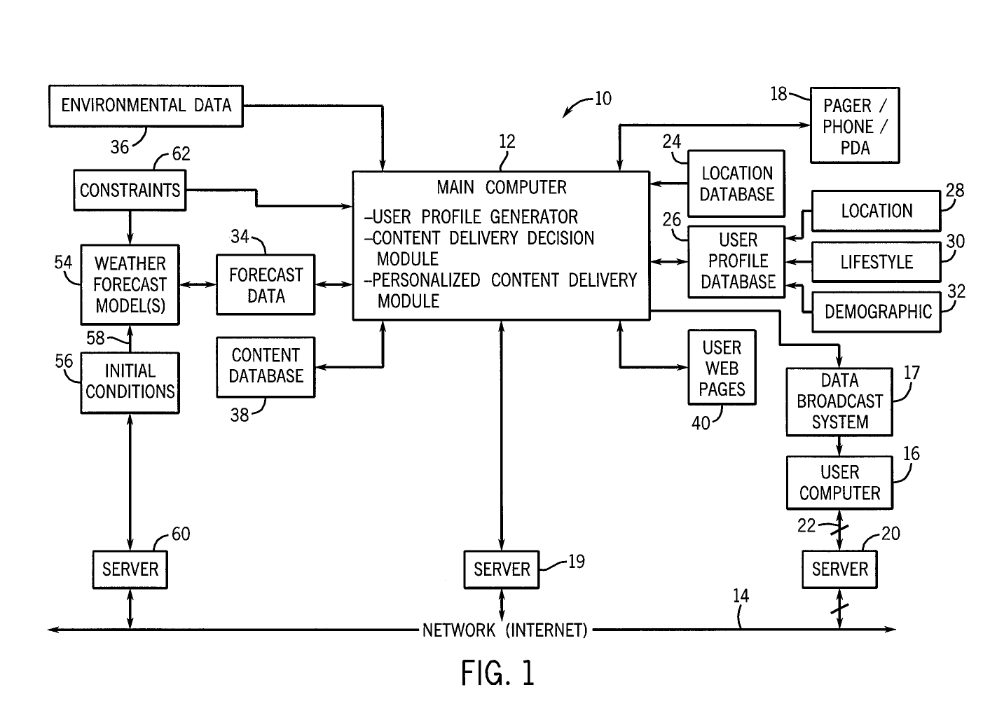

A schematic block diagram of an exemplary system 10 for generating and delivering targeted information content using a combination of environmental and other (e.g., location of interest/demographic/lifestyle-) information in accordance with the present invention is illustrated in, and will be described in detail with reference to, FIG. 1. In accordance with the present invention, the targeting of information content delivery to selected content recipients who are most likely to be interested in receiving such information content, based on a combination of environmental and content recipient demographic information, may be implemented in software in a main computer system 12. It should be understood that the functions of the main computer system 12 to be described in more detail below may be performed by a single computer, or by several computers operating in combination and/or networked together to perform the functions of the main computer system 12. Thus, the main computer system 12 may be implemented as one or more conventional computers located at one or more various locations.

The main computer system 12 may communicate, e.g., via a network connection 14, with a potential information content recipient's computer 16. The potential content recipient's computer 16 may be implemented in a conventional manner as a personal or hand held wireless computer, WebTV terminal, digital television system, or the like. Two-way communications between the main computer system 12 and the potential content recipient's computer system 16 may be provided over any suitable communications network or link 14. Alternatively, communications between the main computer 12 and the potential content recipient's computer 16 may be via any known or future data network system 17. The main computer system 12 may also, or alternatively, be in communication with other potential information content recipient communication devices 18, such as an alpha numeric pager, digital cellular or other telephone, wireless personal digital assistant (PDA), personal navigation device or any such similar communication device.

Preferably, and conveniently, the main computer system 12 and the potential content recipient's computer 16 may communicate with each other via the Internet 14, using conventional and widely known Internet communications formats, protocols, etc. The main computer system 12 and the potential content recipient's computer 16 may be connected to the Internet 14 in a conventional manner via servers 19 and 20, respectively. Note that the server 19 providing an Internet connection to the main computer system 12 may be separate from or an integral part of the main computer system 12. The server 20 providing an Internet connection for the potential content recipient's computer 16 may typically be provided by a commercial Internet service provider. Communications between the potential content recipient's computer 16 and the Internet service provider's server 20 may typically be accomplished using a modem connection for communications over conventional telephone lines, cable television lines, or other physical or radio links 22. It should be understood that the main computer system 12 may obtain demographic and other information from, and deliver targeted information content to, many content recipient's computers 16 connected to the main computer system 12 over the Internet in the manner to be described in more detail below. For example, a single Internet service provider server 20 may provide a connection to the main computer 12 over the Internet 14 for many potential content recipients' computers 16, and an essentially unlimited number of servers may be on the Internet 14. Where the main computer system 12 is in communication with another potential content recipient communication device 18, conventional and known communication protocols may be employed, e.g., to provide text and/or graphical or audio information content to the communication device 18 from the main computer system 12, and to receive information from the potential content recipient via the user communication device 18.

As mentioned above, the main computer system 12 may be implemented in a conventional manner using a single computer or multiple computers network together to perform the functions required. The main computer system 12 may include conventional computer peripheral devices (not shown), including input and output devices such as keyboards, mice, monitors, printers, etc. The main computer system 12 will also include conventional computer memory devices, which may include disk or tape storage devices for storing the computer programs which will be run on the main computer system 12 to implement a method for targeting the delivery of information content to content recipients based on a combination of environmental and other information in accordance with the present invention. Exemplary functions to be performed by the main computer system 12 to implement the invention include a user profile generator, for obtaining user location of interest/demographic/lifestyle information, a content delivery decision module, for determining which information content will be targeted to which potential content recipients based on a combination of the user profile data and environmental data, and a personalized content delivery module, for delivering the selected information content to selected targeted information content recipients in a desired format. Each of these functions will be described in more detail below.

Memory, e.g., disk storage space, etc., also is provided for the storage of database information which is employed by the programs running on the main computer system 12 for targeting information content delivery using a combination of environmental and other data in accordance with the present invention. Databases stored in memory may include, for example, a geographic location database 24, a user profile database 26, including potential content recipient profile data such as potential content recipient location of interest 28, lifestyle 30, and other demographic 32 data, at least one database of environmental information, e.g., a weather forecast database 34 and/or database of other environmental data 36, and a content database 38 of content to be delivered to selected targeted content recipients based on a combination of environmental data and user profile data. The use of each of these exemplary databases 24, 26, 34, 36, and 38 in delivering targeted information content to a selected content recipient based on a combination of environmental and other information will be described in detail below. It should be noted that information in each database 24, 26, 34, 36, and 38 may be stored in its own memory device, e.g., disk, or together on the same disk or other memory device with other database information. It should also be noted that the term “database” as used herein, including in the attached claims, refers generically to any collection of information or data, and is not meant to be limited to any particular way of storing, organizing, or retrieving such data, such as a relational database. Memory capacity 40 preferably also may be provided for storing targeted information content in the form of personalized user Internet web pages, as will be described in more detail below.

The process of targeting information content delivery using a combination of environmental and demographic or other information in accordance with the present invention requires the establishment of a user profile database 26. The user profile database 26 includes user profile data from many potential information content recipients. A potential information content recipient is any individual, business, or the like who is a potential recipient of any selected information content. The user profile database 26 preferably includes various demographic and other information related to many potential content recipients. Based on a combination of the potential content recipient demographic or other information provided in the user profile database 26 with environmental, e.g., forecast weather condition, data, the main computer system 12 determines which selected ones of the potential content recipients identified in the user profile database 26 should receive specific selected information content.

Various types of demographic and other information may be provided for each potential information content recipient in the user profile database 26. Typical information to be included in the user profile database 26, along with potential content recipient identification information (e.g., individual or business names), includes user locations of interest 28 (e.g., home or business address, address of business activity, etc.), lifestyle information 30 (e.g., recreational or business activities in which the potential content recipient is interested in participating) and other demographic information 32 (e.g., individual occupation, age, sex, income information, family status, product ownership, home ownership, etc., and corresponding information for business recipients).

The user profile database 26 employed by the system 10 for targeting information content delivery using a combination of environmental and other information in accordance with the present invention may be obtained and/or populated in any conventional or other manner. For example, potential content recipient profile (e.g., demographic) information may be obtained for the user profile database 26 from sellers of such information. Alternatively, the computer system 12 may gather the potential content recipient profile information required to populate the user profile database 26 from various open information sources available, e.g., on the Internet. Conveniently, the system 10 may obtain potential content recipient demographic and other information for the user profile database 26 directly or indirectly from potential content recipients. Any one or any combination of these methods for obtaining potential content recipient profile information to populate the user profile database 26 may be employed.

In one exemplary application of a system and method for targeting information content delivery using a combination of environmental and other information in accordance with the present invention, the present invention may be implemented as part of a system for providing other information, products, or services, of value or interest to potential targeted information content recipients. In such a case, in particular, information needed to populate the user profile database 26 may be obtained directly from potential content recipients as part of the process of providing the recipients with the information, products or services they desire. In this case, potential content recipient profiles in the user profile database 26 may be established by each potential content recipient himself For example, a potential information content recipient may establish a user profile by connecting with the main computer system 12 over, e.g., the Internet 14. A user profile generator function, running on the main computer system 12, may preferably provide a user profile set-up menu user interface as a webpage which may be accessed by the potential content recipient over the Internet. The potential content recipient enters the requested user profile information, e.g., location of interest, lifestyle, and other demographic information, into the user profile set-up menu user interface as part of the process of ordering a product, service or information. Individual user profile information for many potential information content recipients thereby may be obtained to populate the user profile database 26.

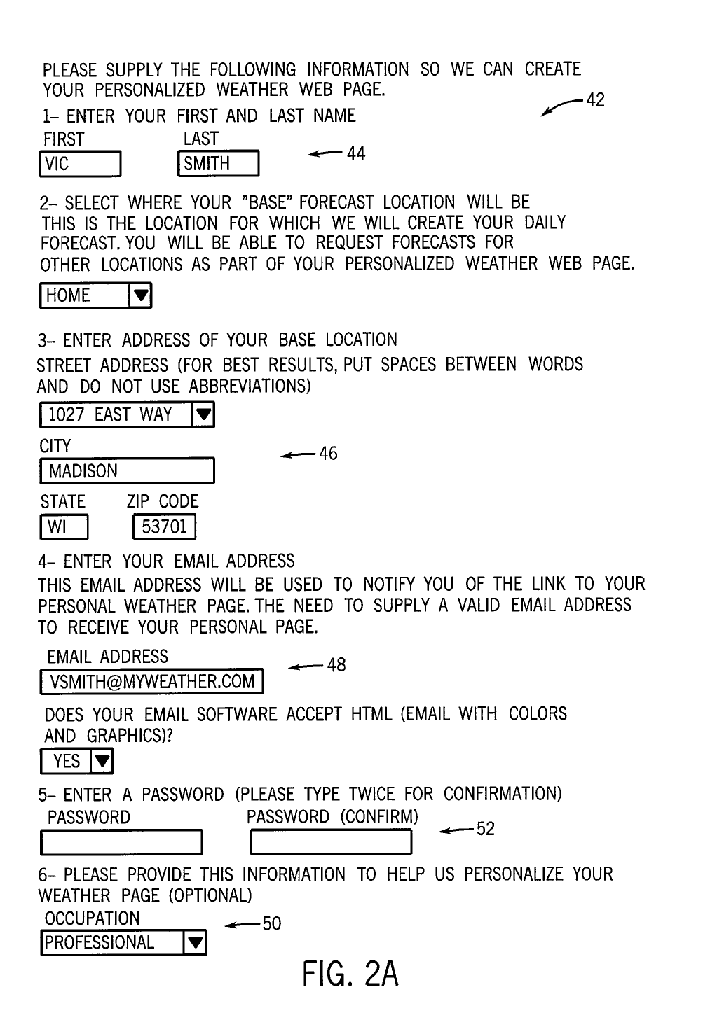

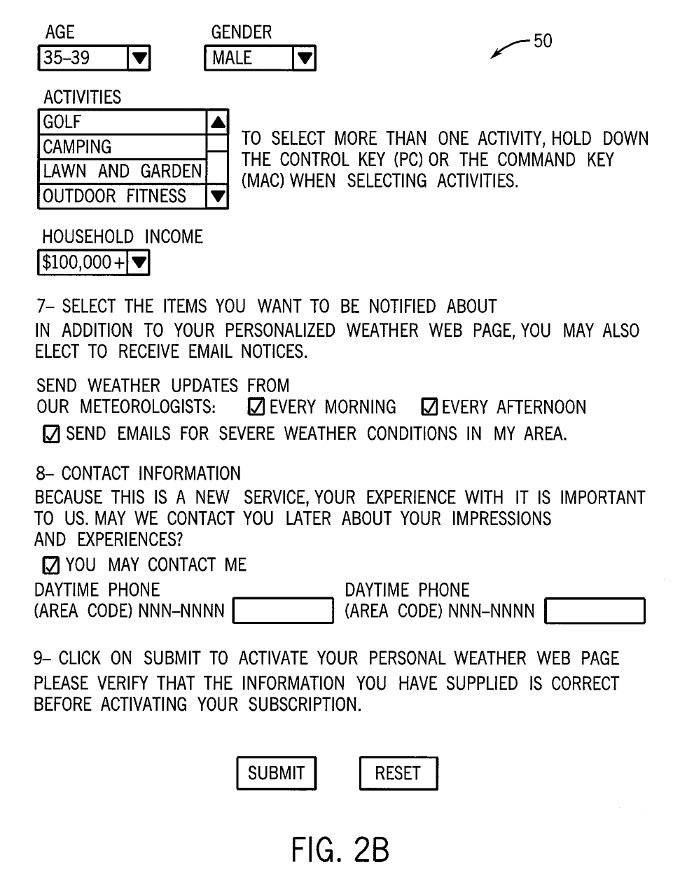

An exemplary user profile set-up menu user interface 42 which may be used to obtain potential information content recipient profile information to populate the user profile database 26 is shown in FIG. 2. This particular user profile set-up menu user interface 42 may be used to obtain user profile information required or desired to provide personalized weather reports to users, as described, for example, in U.S. patent application Ser. Nos. 09/547,195 and 09/686,029, both entitled SYSTEM AND METHOD FOR PROVIDING PERSONALIZED WEATHER REPORTS AND THE LIKE, the disclosures of which are incorporated herein by reference. The user profile information obtained from potential information content recipients to provide, in this case, personalized weather report information to the recipients, along with other information obtained via the user profile set-up menu user interface 42, is also used to target information content delivery to selected ones of the potential information content recipients using a combination of environmental and user profile demographic and other information in accordance with the present invention. A user profile set-up menu user interface requesting other, or additional, information may be used, particularly if the present invention is employed in association with systems for providing goods or services other than personalized weather reports.

The exemplary user profile set-up menu user interface 42 prompts a potential information content recipient to provide a name 44 (or other identification information), location of interest information 46 (e.g., home or business address, or location of business activity), user contact information 48, and other user demographic/lifestyle information 50 (e.g., user occupation, age, sex, activities of interest, income level, etc.). The user profile set-up menu user interface 42 may also prompt the user to provide other information, e.g., billing, e.g., credit card, information for the requested product or service, additional contact information, etc.

The location of interest information 46 is, in this case, the geographical location for which the potential information content recipient is interested in receiving detailed personalized weather information. Alternatively, the location of interest information 46 may simply be a potential content recipient's home or work location, or the location of business or other activity, such as a construction site. Various methods may be used to identify locations of interest. For example, the potential content recipient may provide a street address or a United States Postal Service Zip+4 code, either of which will identify the location of interest with sufficient detail.

Where the environmental information used in combination with demographic or other information to target information content delivery is forecast weather condition information, e.g., as provided by a high resolution weather forecast model, as will be discussed in more detail below, it may be necessary to translate the location of interest information as entered by the potential information content recipient in the user profile set-up menu user interface 42 into an appropriate coordinate system. Weather forecast model data may typically be produced for geographic locations identified by latitude and longitude coordinates. In such a case, it will typically be necessary to convert the location of interest information 46 entered by the potential content recipient in the user profile set-up menu user interface 42 into a latitude/longitude coordinate. For this purpose, the main computer system 12 may employ the geographic location database 24, which may include a table or other data structure for converting street addresses, Zip+4 codes, etc. to corresponding latitude/longitude coordinates.

The contact address 48 may be the address to which the potential information content recipient would like requested information, e.g., in this case, a personalized weather report, to be sent. This address may preferably also be the address to which targeted information content is delivered, and may be specifically identified as such to the potential content recipient. The contact address 48 may be, for example, an Internet e-mail address, for providing requested information and targeted information content to the selected content recipient's computer 16 over the Internet 14. Alternatively, or additionally, the contact address may identify other destinations or media for transmitting information content to a selected recipient. For example, information content may be provided by the main computer system 12 to a recipient's alphanumeric pager, digital cellular phone (e.g., using a conventional voice synthesizer), or PDA 18 (See FIG. 1), in which case the contact address may be a cell phone or pager number, etc. Alternatively, or additionally, the computer system 12 may generate automatically a personalized Internet web page address, at which the user requested information (e.g., personalized weather report) will be accessible along with information content targeted to the selected recipient. The content recipient's personalized Internet web page address for receiving such information content may be provided to the recipient at the recipient's designated contact address 48. For example, the content recipient's personalized Internet web page address may be provided in an e-mail or phone message provided to the recipient at the recipient's provided contact address 48.

Having established a content recipient profile, e.g., using the user profile set-up menu user interface 42, the profile may be saved by the main computer system 12 in the user profile data base 26. Many individual user profiles may be established by individual potential information content recipients and saved by the main computer system 12 in the user profile data base 26. A potential information content recipient preferably may be able to change any recipient definable portion of his recipient profile at any time, by re-accessing the user interface menu 42, e.g., over the Internet connection 14, and making any desired changes. For security purposes, a potential content recipient may be requested to establish a user password 52 upon initially establishing a profile, and may be prompted to enter this password before being allowed to make any changes to a previously established profile.

Various types of environmental data 36 may be provided to the main computer system 12 for combination with demographic and other information from the user profile database 26 to target information content delivery to selected potential content recipients in accordance with the present invention. The environmental data 36 may include weather data (e.g., past, present, and forecast weather data), and/or environmental data related to other generally naturally occurring phenomena (e.g., pollen counts, geological activity, animal migrations, etc.). Environmental weather data, in particular, may be provided from a variety of weather data sources, e.g., weather radars, weather satellites, local and remote weather stations, observations, etc., in a conventional manner.

An exemplary application of the present invention using forecast weather data will now be described in further detail. It should be understood, however, that a system and method in accordance with the present invention for targeting information content delivery using a combination of environmental and other information may employ environmental information other than, or in addition to, weather information in general, and forecast weather information in particular.

Forecast weather condition data 34 may be provided to the system 10 manually by a meteorologist or other weather forecaster. However, in a preferred automated system, weather forecast data 34 is provided automatically using a computer based weather forecast model or models 54 (See FIG. 1). The weather forecast model or models 54 employed to generate the weather forecast data 34 may be implemented as part of or separate from the main computer system 12. An exemplary weather forecasting model which may be employed to generate detailed and high resolution weather forecast data for geographical areas of interest is the commercially available ADONIS Microcast weather forecast modeling product available from Weather Central, Inc., of Madison, Wis. This product is capable of providing high geographic and temporal resolution weather forecast data using reasonable computation resources and computation times. This model employs initial atmospheric condition data 56, which is computed at a central location from “raw” observational data provided by the National Weather Service and other agencies. The initialization data 56 is provided periodically, e.g., twice a day, to the weather forecast model 54. The initial conditions 56 may be provided to the computer system (e.g., the main computer system 12) running the weather forecasting model 54 via a direct communication link 58 (e.g., a satellite link) or, alternatively, via the Internet 14, via a server 60, in either case using conventional data transfer protocols.

The detailed high resolution weather forecast model data 34 generated by the forecasting model 54 employed may be subject to constraints, provided via a constrainer module 62, before such model data is employed in combination with demographic and other data to target the delivery of information content to selected content recipients. The constraints 62 may be provided in a variety of ways. For example, constraints 62 may be provided to the weather forecasting model 54 or to the main computer system 12 by a meteorologist or other operator entering such constraints directly into the computer system 12 via a keyboard or other input devices associated therewith. Alternatively, or additionally, constraints 62 may be provided to the computer system 12 from a remote location, e.g., via a direct communications link (e.g., a satellite link) or via the Internet 14 or another communications network. Constraints 62 may be applied to any modeled weather condition, e.g., temperature, wind speed, precipitation, etc., and may be applied throughout an entire modeled geographic area, or to selected portions thereof. The constraints 62 limit the modeled weather conditions which are used in combination with demographic or other information to target the delivery of information content to selected content recipients to whom such content is most likely to be of interest. The use of constraints may enhance the accuracy of subsequent decision making with regard to which content will be targeted to which selected content recipients. For example, a meteorologist may determine, based on experience and/or information which is not available to the model employed, that, for example, the forecast high temperature or precipitation for a modeled region and time will not exceed certain levels. Such limits may be provided as constraints 62 to the forecast model data results 34, resulting in a more accurate determination of whether or not selected information content is to be delivered to selected content recipients to whom information content is to be delivered only if certain temperatures or precipitation levels are forecast.

The content database 38 contains the information content which is to be delivered to selected content recipients in a targeted manner based on a combination of environmental and user profile location of interest/demographic/lifestyle information in accordance with the present invention. Any type of information content may be contained in the content database 38. Information content may be stored in the content database 38 in a format appropriate so as to be delivered to selected targeted content recipients in the format desired (e.g., a text or html file to be delivered via e-mail or to an Internet web page, a digitized voice file to be delivered to a cellular phone, etc.). An example of information content which may be stored in the content database 38 is advertising campaign information. Such advertising information content may include a variety of different advertisements in different forms for different products and services that may be delivered to selected content recipients over various media. In accordance with the present invention, such advertisements or other information content are delivered in a targeted manner to selected content recipients based on a combination of recipient location of interest/demographics/lifestyle information and environmental (e.g., weather) information.

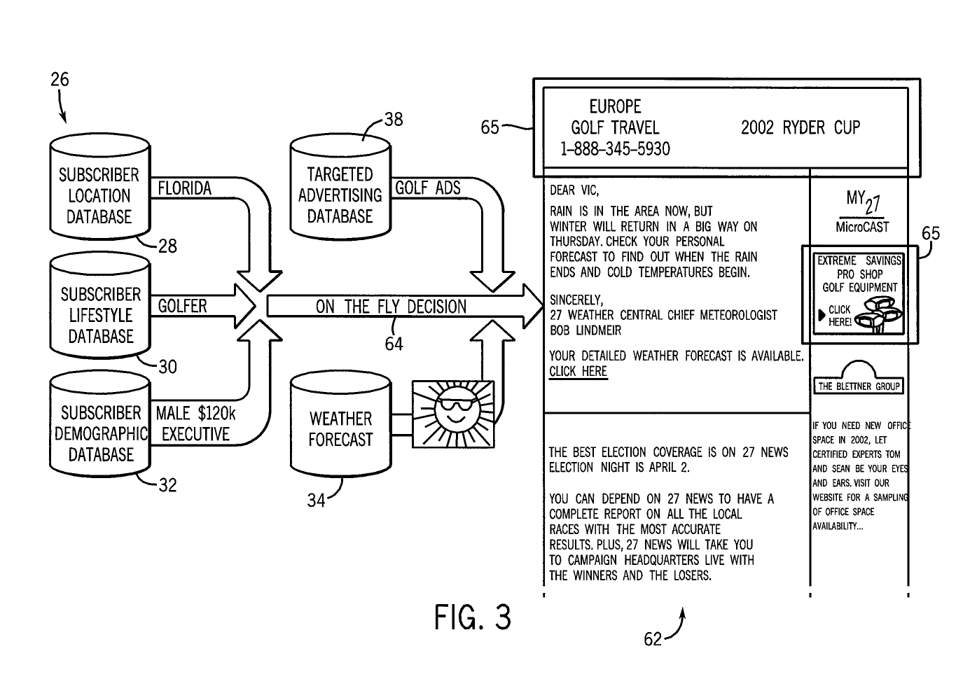

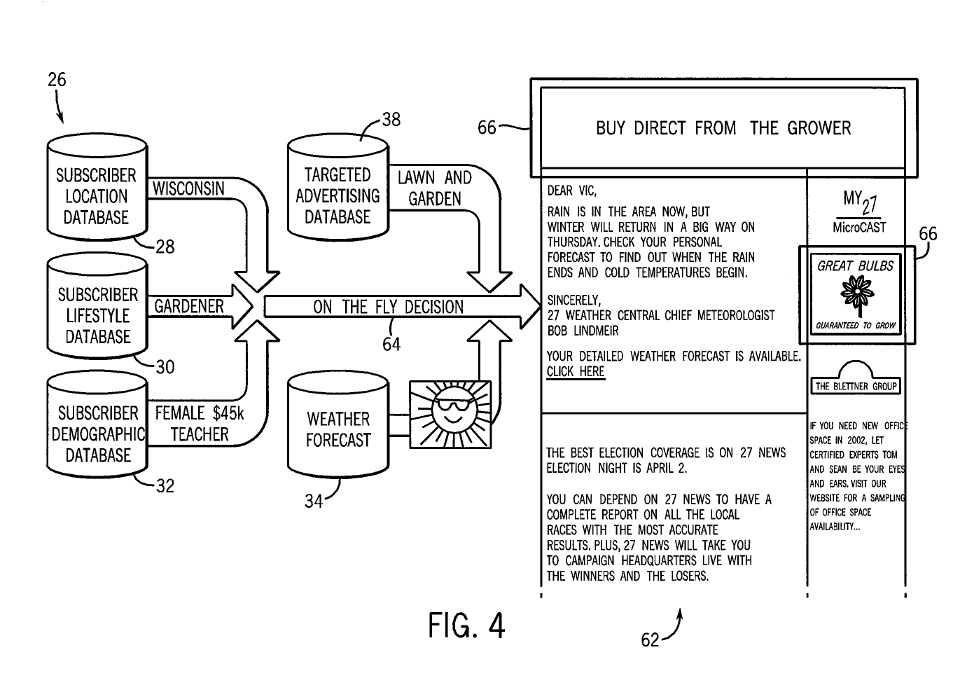

Illustrations of an exemplary implementation of a method for targeting information content delivery to selected information content recipients using a combination of environmental and user location of interest/demographic/lifestyle information are presented in FIGS. 3 and 4. In the exemplary implementation illustrated, the environmental data used for targeting content delivery is weather forecast data. As has been discussed previously, other or additional environmental information might also be employed. Also, with regard to the exemplary implementation illustrated in FIGS. 3 and 4, the content to be delivered in a targeted manner to selected content recipients is advertising information. As also discussed above, in accordance with the present invention, any type of information content may be delivered in a targeted manner to selected content recipients based on a combination of environmental and location of interest/demographic/lifestyle information in accordance with the present invention.

The exemplary implementations illustrated in FIGS. 3 and 4 show how a system for targeting information content delivery using a combination of environmental (in this case weather forecast) and demographic information may be implemented in combination with a system for delivering personalized weather reports to subscribers. In this case, user profile information may be obtained from subscribers to a service providing personalized weather reports in the manner described above with respect to FIG. 2. As discussed, such potential information content recipient profile information may include a user location of interest 28, activity of interest (lifestyle) 30, and various other demographic 32 information stored as parts of a user profile database 26. Weather forecast data 34, e.g., as provided by a high resolution weather forecast model 54, may be combined with selected recipient profile information, such as the recipient location of interest 28, to generate a personalized weather report 62 for the subscriber, which may be delivered to the subscriber at the contact address provided by the subscriber. For example, as illustrated in FIGS. 3 and 4, a personalized weather report 62 may be provided as an html e-mail message. (Although, as discussed above, it should be understood that such a personalized weather report might be delivered to a personalized Internet web page, or via media other than the Internet.)

In the exemplary implementations in accordance with the present invention illustrated, an information content delivery decision 64, e.g., in this case, an advertisement placement decision, is made automatically based on potential content recipient profile data (location 28, lifestyle 30, other demographic 32) in combination with weather forecast data 34. This decision 64 preferably may be made automatically, or on the fly, e.g., in this case, each time a personalized weather report is generated for a potential content recipient subscriber. The information content delivery decision, in this case, advertisement placement decision 64, may apply various preset or dynamic criteria to determine the information content, in this case advertisement placement, to deliver to the selected content recipient which will be of most value to, or, in this case, most likely to be responded to by, the selected content recipient based on available recipient profile and, in this case, weather forecast information. The criteria employed to determine which information content (e.g., advertisements) is to be delivered to which selected content recipients based on a combination of environmental and location/demographic/lifestyle information will depend upon the nature of the information content to be delivered.

As illustrated in FIG. 3, for example, a content database 38, in this case a database of advertisements to be targeted to subscribers of a service for receiving personalized weather reports, includes advertisement campaign information related to golf. However, not all subscribers to the personal weather report service will have any interest in golfing. Delivering golf related advertisements to such uninterested subscribers would be very ineffective. Furthermore, even those who are interested in golf are less likely to be responsive to advertisements for golf products and services if forecast weather conditions for the near future for the subscriber's location of interest are not conducive to playing golf. In accordance with the present invention, for example, golf advertisements are only delivered to a targeted group of subscribers to the personal weather report service whose demographic/lifestyle profile indicates a likely interest in golf and if forecast weather conditions for the subscriber's location of interest are appropriate for golf. Thus, for example, FIG. 3 illustrates application of the exemplary implementation for a subscriber having a home in Florida who has a stated interest in golf and an income level which indicates a potential interest in high end golf services and equipment. (This location/demographic/lifestyle information is stored in the user profile database 26.) The combination of this location/demographic/lifestyle information with weather forecast information 34 indicating good golfing conditions for the subscriber's location of interest in Florida results in the decision 64 to target golf advertisements from the targeted advertising database 38 to this particular subscriber. In this case, for example, a golf advertisement 65 is included in the personalized weather report e-mail message 62 delivered to this subscriber.

FIG. 4 illustrates how the same implementation would be applied in the case of a subscriber having a location of interest in Wisconsin, who has an indicated interest in gardening, and a more moderate income level. In this case, the location/demographic/lifestyle information (stored in the user profile database 26) for this subscriber is combined with the weather forecast data 34 indicating good gardening weather in the near future for the subscriber's location of interest, resulting in an automated decision 64 to deliver lawn and garden related advertisements from the advertising content database 38 to the subscriber. In this case, for example, a gardening related advertisement 66 is included in the personalized weather report e-mail message 62 delivered to the subscriber.

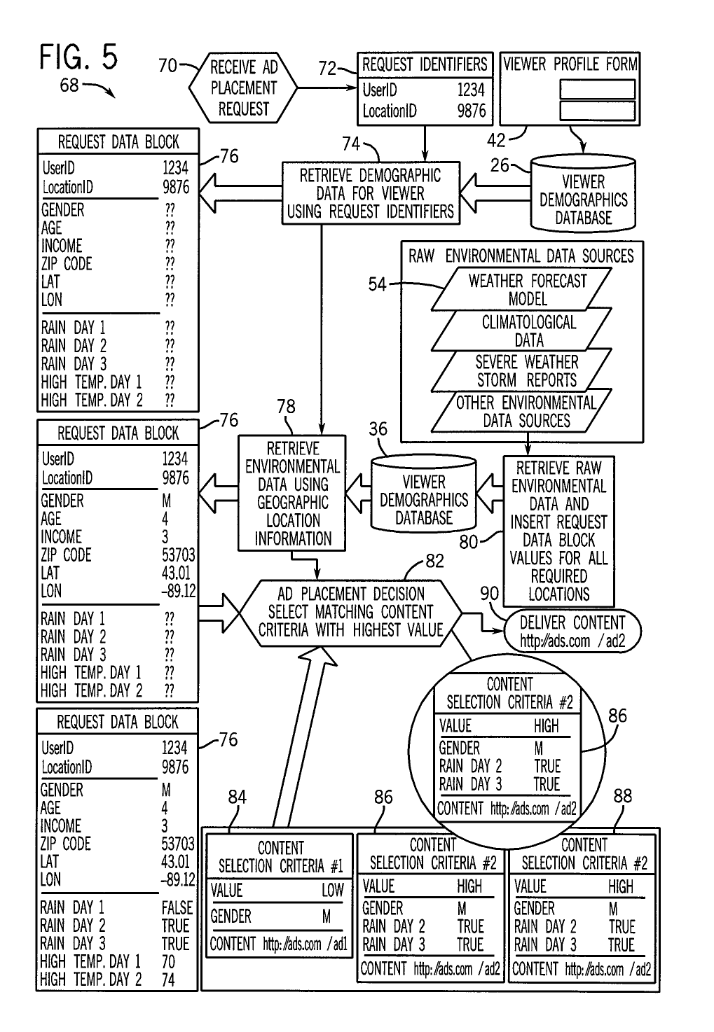

A schematic flow chart diagram of an exemplary method 68 in accordance with the present invention for targeting the delivery of information content (in this case, advertising campaign materials) using a combination of environmental (in this case weather forecast) information and demographic or other information is presented in FIG. 5. The process begins at step 70 when a request is received by the system to deliver information content, e.g., advertising materials, to selected information content recipients. This request 70 may be generated automatically periodically for each potential content recipient. Alternatively, the generation of such a request 70 may be triggered by the occurrence of an event. For example, for a system in which the present invention is implemented in combination with a service for providing personalized weather reports to subscribers, an advertisement placement request 70 may be generated automatically for each subscriber to the service each time a new personalized weather report is generated for the subscriber (e.g., twice each day).

Each request 70 for the targeted delivery of information content to selected content recipients may be accompanied by a request identifier 72. The request identifier 72 identifies a potential information content recipient. For example, each request identifier 72 may include a user ID number identifying a potential information content recipient (e.g., a personalized weather report service subscriber) and a location ID number identifying a location of interest for that subscriber. The location ID number may be used if more than one location of interest may be identified by or for the same potential content recipient. Alternatively, the request identifier 72 may include a single unique user ID number for each user/location of interest combination. The request identifiers 72 may be stored in a database of potential information content recipients (e.g., a database of personalized weather forecast service subscribers).

At step 74 demographic and related information for potential recipients of targeted information content is retrieved from a database of such information. For example, such demographic information may be stored in a user profile database 26 as described above. As also discussed above, the user profile database 26 may be populated by users themselves, e.g., by subscribers to a personalized weather report service entering requested information into a user profile set up menu user interface form 42. The demographic and related information may be retrieved from the database 26 of such information using the information provided in the request identifier 72. For example, the user ID number from the request identifier 72 may be used to retrieve from the database 26 user demographic information for the potential information content recipient identified thereby. Similarly, the location ID number from the request identifier 72 may be used to retrieve from the database 26 a latitude/longitude coordinate for the potential information content recipient location of interest identified thereby.

The demographic attributes for the potential information content recipient retrieved in step 74 may be used to populate the demographic data portion of a request data block 76 established for the potential information content recipient. The demographic data portion of the request data block 76 may include variously categorized demographic information including a potential information content recipient's location of interest, which may, as discussed above, be identified by a latitude and longitude.

At step 78 environmental data is retrieved from an environmental information database 36 to populate an environmental data portion of the request data block 76 for the potential information content recipient. As discussed above, the environmental information database 36 may be populated with various types of environmental information from a variety of different environmental information data sources. As also discussed above, for example, such environmental information data sources may include weather information data sources, such a weather forecast models 54 for providing weather forecast data. For example, in this case, weather forecast information is retrieved 78 from the weather forecast database 34 for the recipient's location of interest (in this case, identified by latitude and longitude in the demographic data portion of the request data block).

It should be noted that environmental information retrieved from the environmental information database 36 may be derived from information provided by one or more environmental information data sources, e.g., a weather forecast model 54, each time a request is made for such environmental information corresponding to a potential information content recipient's location of interest. Alternatively, environmental information may be derived from information provided by one or more environmental information data sources periodically, or in response to the occurrence of a specific event, with the latest environmental information thus derived stored in the environmental information database 36 for ready retrieval whenever a request for targeted information content delivery is received. In either case, raw environmental data provided from the environmental information data sources preferably is processed 80 and stored in the environmental information database 36 in a format for ready retrieval therefrom into the environmental data portion of a request data block 76. Such processing 80 of the environmental information provided by the environmental information data sources may include retrieving environmental data from the environmental information data source or sources and translating the raw environmental data received from such sources into a useful format in which the data may be saved in the environmental information database 36. For example, raw weather forecast model data provided by a weather forecast model data source 54 may be processed 80 by retrieving the model data from the model 54 and translating, using known manual or automatic techniques, the raw model data into simple weather forecast data entries (e.g., rain or no rain, high and low temperatures, etc.) for possible information content recipient locations of interest within a given area. Known techniques for processing 80 raw environmental data from environmental information data sources into useful environmental information to be stored in the environmental information data base 36 may be used. The exact processing 80 techniques to be employed will depend on the natures of both the environmental information data source and the desired processed environmental information data format.

Environmental data is thus combined with demographic data for a potential information content recipient within a request data block 76 to form a set of recipient attributes including environmental attributes. For example, as illustrated in FIG. 5, environmental data attributes may be combined with the retrieved demographic information attributes to create a request data block 76 containing a combination of attributes defining a potential information content recipient by demographic and, in this case, predicted forecast weather conditions at the recipient's location of interests (e.g., whether or not precipitation is likely within the next few days and predicted high temperatures for the next few days).

At 82, the combined environmental and demographic information attributes in the request data block 76 for a potential information content recipient are provided to the information content delivery decision module. In this case, since the information content to be delivered is advertising campaign materials, the information content delivery decision module is implemented as an advertisement placement decision module. The advertisement placement decision module allows users to design advertising campaigns by selecting desired attributes from a set of categories and possible values that have been established for the system. In accordance with the present invention, the desired attributes will include a combination of demographic and environmental attributes. The selected attribute sets can be combined using Boolean operators to specify which advertisement campaigns a specific potential recipient is eligible to receive. Any given potential information content recipient may be eligible to receive many different advertisements or other information content. The advertisement placement decision 82 is called upon to find the most valuable advertisement to deliver based on a selected assortment of dynamic criteria. In this case, the most valuable advertisement to be delivered is an advertisement which is more likely to be responded to based on the known recipient demographic information and, in this case, predicted weather conditions for the recipient location of interest. The advertisement placement decision 82 may attempt to balance competing requirements, such as delivery of a certain advertisement a certain number of times in a month, avoiding repeated delivery to a specific recipient, delivering advertisements in a predetermined sequence based on previous advertisements viewed (session advertising), etc. An exemplary commercially available advertisement placement decision system which may be employed with modification in accordance with the present invention is the AdManager, available from Engage, Inc. of Andover, Mass. Such a system may be employed in accordance with the present invention by modifying the attributes considered thereby to make an advertisement placement decision to include environmental information, such as recent, current, and forecast weather and other environmental information. Such a system also has the ability to track whether a viewer takes action after viewing an advertisement (such as by clicking on the advertisement to obtain further information or to purchase a product or service) and the ability to provide reporting of such recipient response data to a system user in a user friendly format.

In the example shown in FIG. 5, the advertisement placement decision 82 determines which of three advertisements to deliver to a recipient based on a combination of demographic and environmental (in this case weather forecast) selection criteria established for each advertisement. A first set 84 of selection criteria indicate that advertisement ad1 is of low value to potential recipients thereof who are male. A second set 86 of selection criteria indicate that advertisement ad2 is of high value to potential recipients thereof who are male and if rain is predicted for the next few days for the potential recipient's location of interest. A third set 88 of selection criteria indicate that advertisement ad3 is of high value to potential recipients thereof who are male and if the predicted high temperature for the next few days is over 75 degrees. In this case, the demographic and environmental information in the request data block 76 under consideration indicate that the potential advertisement recipient identified thereby is male, that rain is predicted for the potential recipient's location of interest for the next few days, and that the predicted high temperatures for the next few days for the potential recipient's location of interest is below 75 degrees. By applying the selection criteria for the three advertisements discussed above to the combination of demographic and environmental data in the exemplary data block 76, the advertisement placement decision 82 determines that the most valuable advertisement to deliver to the potential recipient is advertisement ad2. (It should be understood that this is a very limited example. In real applications the advertisement placement decision 82 may be based on many more than three sets of selection criteria containing many more attributes than those used by example in FIG. 5.)

At step 90 the advertisement (in this case advertisement ad2) targeted for delivery to a selected recipient by the advertisement placement decision 82 is delivered to the selected recipient in an appropriate manner. For example, as discussed above, advertising information content may be delivered to a recipient via e-mail or at a personalized web page accessible by the recipient and at which other personalized information, e.g., personalized weather reports, are provided to the recipient.

It should be understood that the present invention is not limited to the particular exemplary embodiments illustrated and described herein, but embraces all such modified forms thereof as came within the scope of the following claims. In particular, it should be understood that the present invention may employ environmental information other than weather information to be combined with demographic and other information for targeting the delivery of information content other than advertisements to selected potential content recipients. It should also be noted that the term “demographic information” is used herein, including in the claims, to refer broadly to characteristics or attributes of information content recipients, such as recipient location of interest and lifestyle information, as well as other demographic information, and is not limited to the particular exemplary types of demographic information specifically enumerated herein.

Targeting advertising based on weather differs from targeting advertising based on demographics or the like in two important respects. First, weather is inherently dynamic and difficult to predict. Second, what we call “weather” is in fact a complex combination of many measurements of temperature, relative humidity, wind speed, cloud coverage, precipitation and the like. As a practical matter, these two differences make it difficult to link advertising to weather except in an extremely simple fashion (e.g. serve an umbrella advertisement if it is raining).

The present invention addresses these problems using a sophisticated template and service rule system, in which templates and rules may be associated with particular advertisements. The templates provide for the conflation of multivariable weather data to a simple numeric index that can be used to rank advertisements when multiple advertisements compete for the same impressions, using simple weather categories that are easy for advertisers to understand. The service rules provide a practical way to serve individual advertisements, on a real time basis, using this numeric index, in a manner that is compatible with practical commercial demands.

Typical templates, for example, may be for “grilling”, “golf”, or “sailing”. These templates are based on activities of the consumer. Alternatively, templates may capture weather qualities that precede a demand for certain services, for example “damaging storms”, “flooding storms”.

The goal is to capture multidimensional weather parameters in a single, simple to understand template that can be tested over time. An example template for grilling is provided below:

| Value | −5 | −4 | −3 | −2 | −1 | 0 |
|---|---|---|---|---|---|---|
| Temp | | <=32 | 33-44 | 45-64 or >=101 | 86-100 | 65-85 |
| Relative | | | 91-100 | 81-90 | 51-80 | <=50 |
| Humidity | | | | | | |
| Wspd | | >=21 | 15-20 | 9-14 | 5-8 | 0-4 |
| Cloud | | | | M Cldy or | P Cldy | Clear and |
| coverage | | | | Cloudy | | M Clear |
| Precipi- | Yes | | | | | |
| tation | | | | | | |

In this template, different weather parameters are described by ranges in each of the rows, and the ranges of the columns combine with an implied AND to be associated with a weight value, in this case from 0 to −5. This template, in principle, provides a multivariable function receiving as arguments a variety of different weather parameters, e.g. temperature, relative humidity, wind speed, cloud coverage, and precipitation, and providing the weights as output values. Thus, for example, precipitation is associated with a weight of −5 regardless of the other parameters. Alternatively, for example, no precipitation and a temperature of less than or equal to 32° and a wind speed of greater than or equal to 21 mph is associated with a weight of −4.

The complexity of all of these ranges and weather parameters may be mapped to a single index value by starting at a value of 10 and subtracting the weight value provided by the template. Any total value less than zero rounds up to zero.

In a first example using this template, a grilling index for a locality having a temperature of 76, a relative humidity of 50 percent, a wind speed of 7, partial cloud cover, and no precipitation would be 8. Alternatively a location with a temperature of 38°, a relative humidity of 84%, a wind speed of 8 mph, no cloud cover, and no precipitation would provide a grilling index of 3.

The resulting grilling weather index value may further be mapped to qualitative ranges, for example, as follows:

| Weather index value | Qualitative value |
|---|---|
| 0-2 | Poor |
| 3-5 | Fair |
| 6-8 | Good |
| 9-10 | Excellent |

This is an extremely simple template; however, in general the templates may be more sophisticated including not only weather values but also knowledge about the advertising target. Thus, for example, demographic information about the advertising target, for example as entered by the recipient of the advertising in a personal profile, may be input to the template. In the above example of the grilling weather index value, indicating an interest in grilling, either expressed directly or derived from the profile, may be incorporated as two additional weights added to the weight obtained above (possibly with the adjustment of the starting number of 10 to 11).

| Value | 0 | −1 |
|---|---|---|
| Expressed | yes | no |
| Interest in | | |
| Grilling | | |

Importantly, the template may provide indications of when the weather is to be evaluated. Thus, the weather used to target the advertising need not be today's weather as typically contemplated by most targeting systems but may select among a range of relative and absolute dates. In the present invention, the template may provide for the following weather evaluation dates that determine the date for which the parameters applied to the template are collected or forecast.

| Weather evaluation | |
|---|---|
| date | Description |
| Today | Weather forecasts within 24 hours of |
| | advertisement service |
| N days ahead | Weather forecast (or recorded conditions) |
| (or behind) | N days from date of advertisement service |
| Next Saturday | Weather forecast for the coming Saturday |
| Next Sunday | Weather forecast for the coming Sunday |
| Next Weekend | Weather forecast for the next weekend day |
| Absolute Date | Weather forecast for an absolute date, for |
| | example, the 4th of July. |

Critically, additional weather template value recognizes the fact that purchasing decisions may be made based on future weather expectations. As an example, purchases for grilling may reflect anticipated weekend weather rather than today's weather when today is a weekday. In addition, the weather evaluation date element of the template provides the ability to look backward in time as may be important for certain advertised services or products such as those used for storm repair where the advertiser may wish to advertise most aggressively after the storm has passed.

Generally, templates may be combinations of multiple templates such as those described above combined algebraically or by ranges and Boolean operators. In this way, for example, it is conceivable to create a template, for example related to golf purchases, that ascribes a high score to a rainy day (evaluated on the date of the service of the advertisement) combined with a clear day that is good for golfing (evaluated on the upcoming weekend). Thus, while the templates facilitate the matching of an advertisement to particular weather conditions, the templates are sufficiently flexible to describe the complex ways in which weather can influence an individual purchasing decision.

In addition, a given advertisement may be associated with several different templates to be treated, for example, as if it were two different advertisements competing with other advertisements. In this way, an advertisement may be served under completely different weather conditions or for two different allied weather conditions. The weather parameters incorporated into the templates may include a variety of weather related data beyond that described above including, for example, precipitation onset, precipitation duration, precipitation cessation, lightning strikes, storm proximity, relative humidity, allergen count, ultraviolet index and the like. A variety of different templates may be prepared beyond those described including templates for: tennis, sailing, hiking, fishing, outdoor sports, skiing, and outdoor cooking.

The template system provides a practical way of managing the complexity of weather targeting for the advertising purchaser who may simply select a predefined template. The template system is ideally combined with service rules also associated with individual advertisements and describing the conditions under which the advertisement is served in light of the index value derived from its template and other conditions of service entered into contractually with the server system. The service rules may provide for threshold level of the index before which the advertisement will be served to a target. In addition, the service rules may describe a minimum number of advertising impressions being either individual services of the advertisement to a target or target response to the advertisement measured, for example, by “click-throughs”.

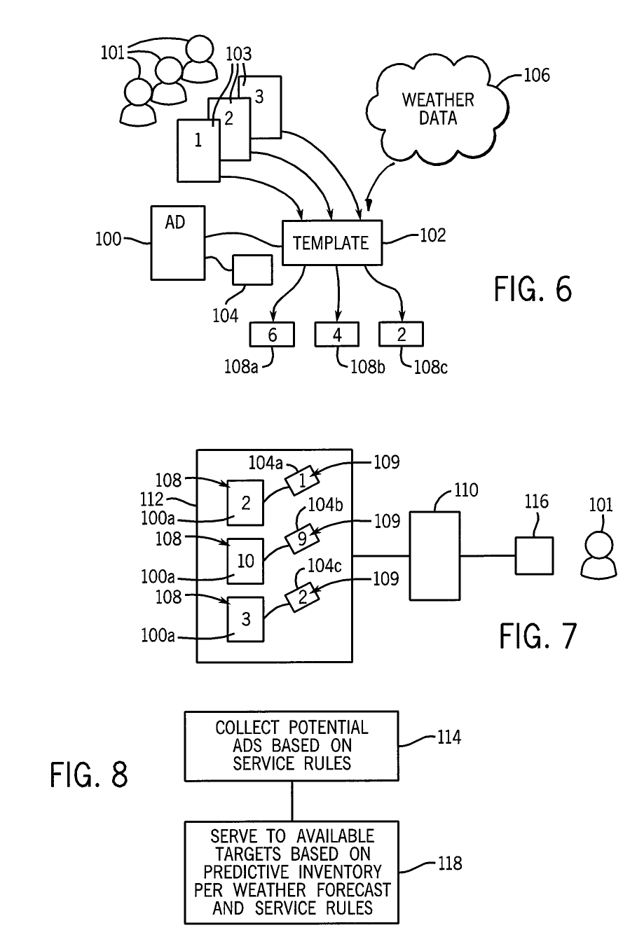

Referring now to FIG. 6, a given advertisement 100, typically a combination of text, images or a script program, for example implementing a banner advertisement on a webpage, may be associated by the advertiser with a template 102 and a service rule 104 describe generally above. The template 102 may be identified by an advertiser using a simple moniker such as “grilling weather”. The service rule 104 describes the threshold of the index value, for example 6, before the advertisement will be served, and may also specify other aspects of the service contract. The present invention contemplates that the following service rules can be employed:

| Service rule | Description |
|---|---|
| Dollar/impression | Cap on total advertising dollars spent, |
| limit | no weather targeting |
| Dollar/impression | Cap on total advertising dollars spent, |
| limits; impression | specified minimum available impression, |
| minimum | no weather targeting |
| Dollar/impression | Cap on total advertising dollars spent, |
| limit; weather | serve advertisements only to prospects |
| index threshold | with weather index above threshold value |
| Dollar/impression | Cap on total advertising dollars spent, |
| limits; impression | specified minimum available impression; |
| minimum; weather | serve advertisements only to prospects |
| index threshold | with weather index above threshold value |

Each of these service rules is also associated with numeric values, for example on the advertising dollars, minimum available impressions and weather index threshold value. Generally a dollar limit (or number of impressions) may be accurately controlled, where impressions are either instances when the advertisement is served to an individual at a given IP address or in which the advertisement is served and the individual “clicks through” on the advertisement. In contrast, the number of advertisements served depends on the availability of visitors to a website, for example. For this reason, the specified minimum available impression reflects only a relative percentage of the available advertising servings and does not guarantee a specific number of servings or click throughs.

Serving advertisements without weather targeting, as indicated by the first two rows of the above table, is standard practice in the industry, but is included because it may coexist with the present invention. The simplest service rules for weather targeting targets advertisements only when the weather index generated from the associated template is above the target value in the service rule as selected by the purchaser. This level of service may be acceptable to the purchaser because it can be offered at low cost. More generally however, the purchaser will wish to have some assurances of at least the minimum number of the available impressions as indicated by the fourth row of the above table. How this desire for certainty in the available impressions may be met by the present invention is described below.

Referring still to FIG. 6, in operation, the present invention first evaluates the personal profiles 103 of individuals 101 who are available to receive advertisements 100, for example, the individuals having logged on to a suitable webpage for viewing the advertisement. The profiles 103 may be centralized or stored on a remote device as will be described. The data of each of the personal profiles 103 of the individuals 101 may be provided to the templates 102 of all enrolled advertisements 100 together with the necessary weather data 106. The weather data 106 may be for a location linked to an individual 101 by their personal profile 103 (being either the location of the individual 101 or another location of interest to the individual 101) or provided by other means, for example, as GPS data or other location information automatically relayed from the device 116 or derived from the connection to device 116 using geolocation techniques. This input weather data 106 is processed by the templates to provide a set of weather indices 108a-108c associated with each individual 101.

Referring now to FIG. 7, the advertisement server 110 then generates a pool 112 of potential advertisements 100a-100c for each individual 101. This process is shown as process blocked 114 of FIG. 8 and involves reviewing the service rules 104 for each advertisement 100 and the contained weather index threshold 109 to determine whether the advertisement 100, by the terms of its service rules 104 and the weather index 108 derived from its template 102, qualifies for service.

While only three advertisements 100a-100c are shown, it will be understood that this number is substantially unlimited. As described above, the advertisements 100 may be associated with multiple different templates 102, for example some advertisements 11 may be associated with grilling templates 102 and some advertisements may be associated with golfing templates 102. A given advertisement 100 may be associated with multiple different templates 102 having different weather index threshold levels (for example purchased at a lower rate for lower threshold). For these reasons, given advertisements 100 may be represented in the pool 112 multiple times based on different templates 102.

The present invention in one embodiment provides an allocation mechanism to select among the multiple advertisements 100 within the pool 112 to determine which advertisements 100 to serve to a given individual 101 at his or her remote device 116, such as a personal computer, mobile wireless computer, cell phone, multi-function GPS device or the like. Two simple methods of selecting among competing advertisements include “round robin serving” in which advertisements 100 are served in turn or by “random weighted serving” in which advertisements 100 are served randomly according to leading factors. With both of these approaches, an index value is attached to each advertisement 100 every time it is enrolled in a pool 112. When the advertisement 100 is served, its index value is reset to zero. In this case of round robin serving, the allocation may simply be performed by taking the advertisement 100 having the highest index value. A similar result may be produced by random serving, in which a random advertisement 100 is selected, the random selection biased by the index value.

The present invention may alternatively or in addition adopt a weighting or advertisement selection process that takes advantage of the imperfect predictability of weather. For those advertisements 100 having service rules 104 in the second and fourth column of the above table, that is, those advertisements having minimum impression requirements, the advertisement 100 is served having the greatest predictive inventory of unserved advertisements. The predictive inventory considers the duration during which the advertisement is contracted to run (for example, N impressions per month or N impressions before a fixed date) and examines the predicted weather against the template for the advertisement 100. This analysis uses the predicted weather to determine the opportunities (for example date or time ranges) when the advertisement 100 can be served according to its service rules 104. The expected available impressions (e.g. people logging on to a serving website) may then be totaled for these predicted opportunities as indicated by process block 118 of FIG. 8.

Thus, for example, an advertisement associated with grilling may have 15 more days of potential “grilling weather” in the month (per its template and service rules) while roofing repair service may have only a single day of “roofing weather” (per its template and service rules) based on a once in a month storm that occurred two days ago. Assuming that each day has a normalized expectation of 10,000 impressions, and the advertisement associated with grilling has a minimum of 20,000 impressions and the advertisement associated with roofing repair has a minimum of 5000 impressions, the roofing repair case will have precedent over the grilling advertisement based on its predicted inventory computed as follows:

predictive inventory=sum of (predicted available impressions)/actual inventory.

Thus, for the roofing advertisement example the predictive inventory is computed as follows:

predictive inventory=1×10,000/5000=2;

while for the grilling advertisement example of the predictive inventory is computed as follows:

predictive inventory=15×10,000/20,000=7.5.

In this way, the ability to forecast the weather provides for improved implementation of a weather targeting system even when forecasting is not required by the template itself. Note that the above system does not require that the predicted available impressions be the same for each day and in this respect the system may use historical traffic data to provide a more accurate predicted inventory. Generally this system operates to give precedent to advertisements 100 that are unlikely to be fully served in the future. The predicted inventory may be repeatedly recalculated so that the predictions alternately converge on actual inventory as time passes.

This approach assumes that the advertisement purchasing process limits the total number of purchased impressions to be close to an expected number of actual targets available to receive advertisements. As noted, this can be handled by predictions based on historical values a web site hits or the like.

Advertisements having service rules that do not specify a minimum numbers of impressions may be served when there are no other competing advertisements within the pool or maybe given a predetermined de facto minimum to ensure that no advertisements experience zero service. Such de facto minimums may also be applied when using the predictive inventory described above for similar reasons. The service rules may also provide an advertising bid amount (how much the advertiser is willing to pay) that may be applied to the weather index 108 to change the ordering of the served advertisements based on the revenue that will be received from an advertiser.

Establishing a market in weather-targeted advertising can be difficult because of the unpredictability of the targeting opportunities tied to unpredictable weather. Accordingly, the present invention also contemplates a method of assisting advertisers in assessing and purchasing weather targeted advertising.

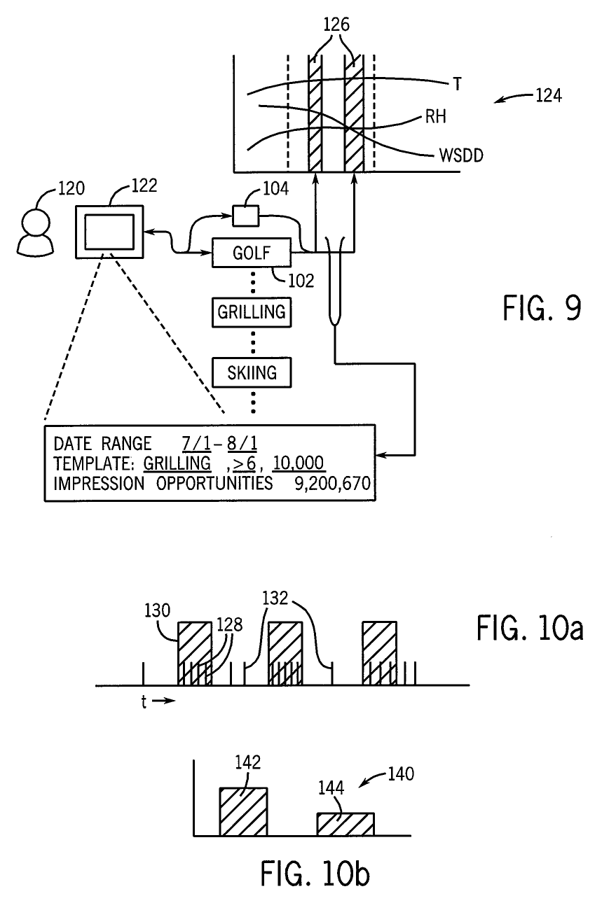

Referring now to FIG. 9, a potential advertising purchaser 120 may enter into the computer system of the present invention as represented by screen 122 indicating a desired date range (D1-D2) of advertisement purchase and may select a template (e.g., grilling weather) from among a set of predefined templates prepared by the current system. This selection may be based, for example, on the descriptive monikers associated with each template (e.g., grilling weather, golf weather, etc.) that may be presented in a pulldown menu (not shown). The purchaser 120 also provides service rules 104 for the purchase of advertisements, in this case indicating that the grilling weather must exceed 6 (>6) and 10,000 impressions are sought as a guaranteed minimum.

The system may then apply the selected template 102 and the service rules 104 against predicted weather parameters 124 for the selected date range (D1-D2) determining time periods 126 during which the weather predictions will match the template 102 and service rules 104. Applying the determined time periods 126 to predicted impressions during those time periods 126, and subtracting any previously purchased impressions from within those time periods 126, the system returns the available impression opportunities that could be purchased by the purchaser 120.

It will be understood that this ability to forecast weather and apply predefined templates 102 against those predictions can be used to construct an auction type system in which impression opportunities and/or particular templates are bid for in advance. By calculating impression opportunities, it is practical to implement weather targeting with some assurances that a certain number of advertisements will in fact be served as is normally preferred by sophisticated advertisers.

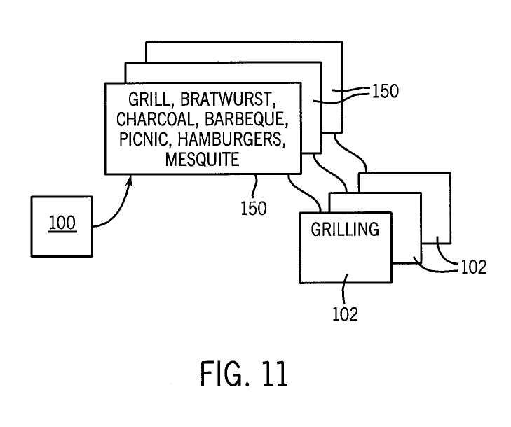

Referring now to FIG. 11, the process of using weather targeted advertising may be further simplified for purchasers 120 by attaching to each template 102 a set of key terms 150 related to the concept of the template. Thus, for example, a “grilling weather” template described above may be associated with key words “grill”, “bratwurst”, and the like. The keywords may be used to scan text of the advertisement 100 for a description of the advertisement 100 prepared by the advertiser to provide for an automatic template identification and to suggest the same to the purchaser. Alternatively, this template identification feature may be implemented automatically.

The present invention contemplates that the value of the templates 102 may be refined by historical monitoring and correction, further improving their value to the purchaser 120. In this respect, templates may incorporate historical experience about the success of given template-based advertising in assessing the templates 102 or modifying the templates 102. Referring now to FIG. 10, this historical data may be obtained by monitoring, for example, “click throughs” for advertisements served at times 128 during periods 130 that match a template associated with the times 128 and by providing, for example free to the client, additional advertising servicing times 132 occurring at times selected randomly without regard to the periods 130 identified by the template associated with the advertisement. The success of the advertisements, for example, as measured by “click-throughs” may then be plotted in a simple bar chart 140 providing two bars 142 and 144, the former indicating “click-throughs” or other metrics indicating the effectiveness of the advertisements using weather target advertising and bar 144 showing the effect of random advertisement without weather targeting. This data may be output on a computer monitor or in printed form and also used to provide guidance to advertisers with respect possible success of their advertising template system.

Improvement of the templates 102 may also be obtained by automatically running two different templates 102 for a given advertisement 100 randomly interspersed and thereby tested and refined. A similar bar chart 140 maybe produced showing the response rate for the different templates 102. In this way the advertiser may obtain the benefit of empirical knowledge conducted by the advertiser only possible by predefined templates.

It will be understood that the template system described above can also be used for the targeting of non-advertising information, for example, a timely article on grilling when the grilling index is above a certain number.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A computerized system for automatic delivery of electronic advertising based on weather conditions comprising:
(a) a data file linking electronic customer addresses to geographic locations of interest;
(b) an advertising database linking electronic advertisements to at least one of a set of weather templates and a service rule;
(c) an electronic server computer programmed to:
(i) determine weather conditions for geographic locations of interest, the weather forecast providing multiple weather parameters;
(ii) map the multiple weather parameters to an index value per a weather template associated with an electronic advertisement; and
(iii) according to the service rule of the electronic advertisement, serve the electronic advertisement to the electronic customer address based on the index value of the weather template for the electronic advertisement.

2. The computerized system of claim 1 wherein the weather parameters are selected from the group consisting of at least three of: temperature, wind speed, cloud coverage, precipitation onset, precipitation duration, precipitation cessation, lightning strikes, storm proximity, relative humidity, allergen count, and ultraviolet index.

3. The computerized system of claim 1 wherein each weather template is associated with a particular activity and the mapping mathematically combines numeric values representing the weather parameters to provide a single numerical index value indicating a suitability of the weather forecast for the associated activity.

4. The computerized system of claim 1 wherein the weather templates define optimal weather for at least one activity selected from the group consisting of: golfing, tennis, sailing, hiking, fishing, outdoor sports, skiing, and outdoor cooking.

5. The computerized system of claim 1 wherein the weather templates define weather associated with damaging storms.

6. The computerized system of claim 1 wherein the service rule includes a time of the weather conditions relative to a time of serving of the electronic advertisement.

7. The computerized system of claim 6 wherein the time is identified to a future holiday or weekend.

8. The computerized system of claim 6 wherein the time is identified to a past time relative to the time of serving of the electronic advertising.

9. The computerized system of claim 1 wherein the weather conditions is for a same date as a date of the serving of the electronic advertising using the weather forecast.

10. The computerized system of claim 1 wherein the service rule blocks the service of the electronic advertisement to the electronic customer address when the index value is below a predetermined threshold.

11. The computerized system of claim 1 wherein the service rule provides for a ranking of multiple different electronic advertisements according to a comparison of their weather index values and wherein the service of the electronic advertisement to the electronic customer address is based on that ranking.

12. The computerized system of claim 11 wherein the ranking considers a minimum desired number of advertising impressions related to the service of the electronic advertisement to an electronic customer address contained in the service rule.

13. The computerized system of claim 12 wherein the ranking of multiple different electronic advertisements evaluates a predictive inventory of potential services of electronic advertisements in the future based on application of a given template to a prediction of weather parameters during a period of serving of the electronic advertisement.

14. The computerized system of claim 1 further including a profile generation program executable on the electronic server computer to receive customer entered data into the customer database indicating weather related preferences by the customer.

15. The computerized system of claim 10 wherein the weather template also maps customer entered data to the index value.

16. The computerized system of claim 1 wherein the weather forecasts are high-resolution weather forecasts specific to an area of less than 5 square miles and updated no less than twice per day.

17. The computerized system of claim 1 wherein each weather template is associated with key words and further including a template selection program executable on the electronic server computer to review text of the electronic advertisements against the key words to identify at least one template for the electronic advertisement.

18. The computerized system of claim 1 wherein the advertising database links at least some of the electronic advertisements to at least two different weather templates and serves electronic advertisements according to the two different weather templates and further including an electronic advertisement monitor monitoring a response to a served electronic advertisement identified to the different weather templates to provide an indication of a relative success of the weather template with respect to responses.

19. The computerized system of claim 1 wherein the electronic server computer further serves electronic advertisements to the electronic customer address independent of the index value of the weather template for the electronic advertisement and collects data indicating response from a customer according to a category of the service of electronic advertisements as being based on the index value or not based on the index value to provide metrics on a success of the weather template.
